(19) United States
(12) Patent Application Publication
(10) Pub. No.: US 2006/0270779 A1
(43) Pub. Date: Nov. 30, 2006

(54) Transparent member for electronic device

(75) Inventors: Tadashi Mochizuki, Kanagawa (JP); Fumiyuki Suzuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/440,099

(22) Filed: May 25, 2006

(30) Foreign Application Priority Data
May 25, 2005 (JP) 2005-152647

(51) Int. Cl. C08G 18/42

(52) U.S. Cl. 524/500

(57) ABSTRACT

A transparent member for electronic device includes: polylactic acid, polymethyl(meth)acrylate, and a flame retardant, the transparent member having an Izod impact strength of 2.7-5 kJ/m² and a light transmittance at 400 nm-760 nm wavelength region of 40% or more. The transparent member for electronic device is made not from fossil resource, but mainly from a carbon-neutral material, and exhibits excellent flame retardancy, impact resistance and transparency.

### CROSS-REFERENCE TO RELATED APPLICATIONS

This application claims the foreign priority benefit under Title 35, United States Code, § 119 (a)-(d), of Japanese Patent Application No. 2005-152647, filed on May 25, 2005 in the Japan Patent Office, the disclosure of which is herein incorporated by reference in its entirety.

### BACKGROUND OF THE INVENTION

1. Field of the Invention

The present invention relates to a transparent member for electronic device, and particularly to a transparent member for electronic device which exhibits excellent flame retardancy, heat resistance and transparency, and which contributes to prevention of global warming.

2. Description of the Related Art

In general, a member for electronic device, especially for copy receiving tray, paper feed tray, document tray and the like of electrophotographic copier, printer, facsimile machine and the like, is required to have flame retardancy and impact resistance as well as transparency. Specifically, the members for copy receiving tray and the like are required to have transparency, for the purpose of easily confirming the presence of paper behind the member, and from the viewpoint of design. In addition, these members are typically held in a predetermined part of the electronic device, and drawn out when necessary. Therefore, the member is required to have enough impact resistance so that it does not crack even when hitting with other members making up the electronic device (usually made from ABS, PC/ABS or the like). Further, these members are typically disposed outside the electronic device, and therefore, required to have flame retardancy. Moreover, these members are required not to be discolored or not to crack by toner used in electrophotographic copier, printer, facsimile machine and the like (i.e., to have toner compatibility).

The member is made from various resins considering their properties and functions required for each member. For example, polycarbonate (PC) is generally used, which is transparent, light and tenacious and has high thermal resistance, excellent impact resistance and excellent electrical insulation property. Polycarbonate is produced by reacting carbonyl chloride or diphenyl carbonate with bisphenol A obtained from petroleum.

Fossil resources, such as petroleum, coal and natural gas, are mainly formed of carbon fixed in soil for a long period of time. When fossil resource or product made therefrom is subjected to combustion, carbon dioxide is rapidly released in the atmosphere. Since the released carbon dioxide is not originated from circulated carbon dioxide but from fixed carbon deep underground, the carbon dioxide in the atmosphere greatly increases, which is one factor of global warming. Accordingly, though polycarbonate exhibits excellent properties as a material for members for electronic device, it is desired that use of such substance obtained from petroleum as fossil resource be reduced from the viewpoint of preventing global warming.

On the contrary, resin derived from plant is originally formed by photosynthetic reaction of carbon dioxide in the atmosphere with water in plant. Even when the plant-derived resin is subjected to combustion and carbon dioxide is released, carbon dioxide balance in the atmosphere is maintained, since the released carbon dioxide is originated from those present in the atmosphere. After all, a total amount of carbon dioxide in the atmosphere is not increased. In this sense, the plant-derived resin is considered as what is called a “carbon-neutral” material. To introduce such a carbon-neutral material is of great importance from the viewpoint of preventing global warming by suppressing increase in total amount of carbon dioxide in the atmosphere.

Polylactic acid is a resin formed of a plant-derived material, not from fossil resource but from saccharides obtained from plant, such as corn. Because polylactic acid is a carbon-neutral material and has a high melting point, and can be subjected to melting-molding, application of polylactic acid is highly expected in various fields. Polylactic acid also has advantages of having a low heat of combustion during incineration, and giving less environmental burden even when discarded in nature, since it is ultimately degraded by microorganisms. In addition, it is highly likely that production cost of polylactic acid would be suppressed to the same level as that of general plastics, when polylactic acid is brought into mass-scale production. Moreover, polylactic acid can be obtained from permanently-regenerating plant which provides safer and recyclable substance, not from petroleum resources which is anticipated to be depleted in the future.

Since polylactic acid itself burns well, polylactic acid is not suitable for use in members requiring flame retardancy, such as members for electronic device. In order to make use of the above-mentioned advantageous properties of polylactic acid, techniques have been proposed, for example, in which a specific flame retardant is added to polylactic acid (see Japanese Patent Application Kokai JP2004-190026 (claim 1)), and in which polylactic acid and other monomer component are copolymerized. However, when a flame retardant is added to polylactic acid to attain a required flame retardancy, such as flame retardancy required for members for electronic device, e.g. V-2 level flame retardancy in the UL94 standard, mechanical strength required for members for electronic device, especially sufficient impact strength, cannot be obtained by injection molding.

Therefore, it would be desirable to provide a member for electronic device solving the above-mentioned problems while exhibiting the above-mentioned required properties, that is, a member for electronic device exhibiting excellent flame retardancy, impact resistance and transparency, which is made not from fossil resource, but mainly from polylactic acid, which is a carbon-neutral material prepared from a plant-derived material.

### SUMMARY OF THE INVENTION

In an aspect of the present invention, there is provided a transparent member for electronic device including polylactic acid, polymethyl(meth)acrylate, and a flame retardant, the transparent member having an Izod impact strength of 2.7-5 kJ/m² and a light transmittance at 400 nm -760 nm wavelength region of 40% or more. Amounts of the polylactic acid, polymethyl (meth) acrylate and the flame retardant may preferably, but not necessarily, be 25-75 parts by weight, 30-75 parts by weight and 0.1-30 parts by weight, respectively. The polyacetic acid may consist essentially of polylactic acid or a blend of polylactic acid with a lactic acid copolymer of lactic acid and a monomer other than lactic acid. The flame retardant may preferably, but not necessarily, be at least one member selected from a phosphorus-containing flame retardant and a silicon-containing flame retardant.

Since the transparent member for electronic device essentially includes polylactic acid, polymethyl(meth)acrylate and a flame retardant, and has an Izod impact strength of 2.7-5 kJ/m² and a light transmittance at a wavelength region of 400 nm-760 nm of 40% or more, the transparent member exhibits excellent flame retardancy, impact resistance and transparency, and is useful as a carbon-neutral member for preventing global warming.

In another aspect of the present invention, there is provided a transparent member for electronic device which is obtained by directly feeding a mixture including the polylactic acid, the polymethyl (meth) acrylate and the flame retardant to a cylinder provided in an injection molding machine, melting and kneading the mixture, and conducting injection molding.

In the case of this transparent member for electronic device, by directly feeding the mixture to the cylinder of the injection molding machine, melting and kneading the mixture and conducting injection molding, the material mixture can be molten, kneaded and molded, without conducing quality governing process, such as preparing crude pellets from the mixture of material components, or preparing a mixture using a master batch produced in advance. As a result, the essential components, such as polylactic acid, are not denatured by heat which would otherwise be generated during the quality governing process, and thus members with excellent quality can be obtained, which also results in excellent cost performance.

The injection molding machine may preferably, but not necessarily, be equipped with a screw having kneading mechanism, with which screw the mixture is mixed and kneaded.

By using the injection molding machine with the cylinder equipped with the screw having kneading mechanism, especially with the screw having kneading mechanism that can exert a large shearing force, the components of the material to be kneaded in the cylinder are dispersed and mixed with a large shearing force, which promotes homogeneous kneading. At the same time, a residence time of the molten-kneaded material in the cylinder can be adjusted to obtain sufficient melting and kneading effect. Therefore, without conducing quality governing process, such as preparing crude pellets or using a master batch, the material mixture can be directly molten and kneaded to perform injection molding.

The transparent member may preferably, but not necessarily, be used for an electrophotographic copier, a printer or a facsimile machine, as a copy receiving tray, a paper feed tray or a document tray.

The transparent member for electronic device of the present invention has flame retardancy and impact resistance as well as transparency required for electronic device. Especially, the transparent member for electronic device of the present invention is suitable as a member for copy receiving tray, paper feed tray, document tray and the like of electrophotographic copier, printer, facsimile machine and the like.

In addition, the transparent member for electronic device of the present invention is made not from fossil resource, but mainly from polylactic acid, which is a carbon-neutral material prepared from a plant-derived material, and therefore use of the member contributes to prevention of global warming. The member has a low heat of combustion during incineration, and gives less environmental burden even when discarded in nature, since it is ultimately degraded by microorganisms.

### DETAILED DESCRIPTION OF THE EXEMPLARY EMBODIMENTS

Next, the transparent member for electronic device of the present invention will be described in detail below.

The transparent member for electronic device of the present invention is formed of resin compound essentially including polylactic acid, polymethyl (meth)acrylate and a flame retardant.

The polylactic acid to be used in the present invention is a polymer mainly formed of L-lactic acid and/or D-lactic acid. A part of the polyacetic acid may be a lactic acid copolymer comprising D/L-lactic acid and monomer(s) other than D/L-lactic acid. Examples of such a monomer unit include, but are not restricted to, glycol compounds, such as ethylene glycol, propylene glycol, butanediol, heptanediol, hexanediol, octanediol, nonanediol, decanediol, 1,4-cyclohexanedimethanol, neopentyl glycol, glycerin, pentaerythrytol, bisphenol A, polyethylene glycol, polypropylene glycol and polytetramethylene glycol; dicarboxylic acid, such as oxalic acid, adipic acid, sebacic acid, azelaic acid, dodecanedionic acid, malonic acid, glutaric acid, cyclohexanedicarboxylic acid, terephthalic acid, isophthalic acid, phthalic acid, naphthalenedicarboxylic acid, bis(p-carboxyphenyl)methane, anthracenedicarboxylic acid, 4,4′-diphenylether dicarboxylic acid, 5-sodium sulfoisophthalic acid, 5-tetrabutyl phosphonium isophthalic acid; hydroxycarboxylic acid, such as glycolic acid, hydroxypropionic acid, hydroxybutyric acid, hydroxyvaleric acid, hydroxycaproic acid and hydroxybenzoic acid; and lactones, such as caprolactone, valerolactone, propiolactone, undecalactone and 1,5-oxepan-2-one. The amount of such a monomer unit is preferably 0-30 mol %, more preferably 0-10 mol %, based on the total amount of the monomer units making up the polylactic acid copolymer.

The polylactic acid may be produced according to conventional methods, for example, by direct polymerization of lactic acid, ring-opening polymerization of lactide, which is a ring product of lactic acid, or the like. The lactic acid to be used as monomer can be produced by saccharifying starch derived from corn, potato or the like and then fermenting the resultant saccharide with lactic bacteria.

The polylactic acid may be modified with, for example, maleic anhydride, epoxy compound, amine or the like, for the purpose of enhancing heat resistance and mechanical properties.

There is no limitation with respect to a molecular weight and a molecular weight distribution of the polylactic acid, as long as the polylactic acid is substantially moldable. However, in general, a weight-average molecular weight is preferably 35,000 or more, and more preferably 50,000 or more. In the present invention, the expression “weight-average molecular weight” means a molecular weight in terms of polymethyl(meth)acrylate, measured by gel permeation chromatography.

Polymethyl(meth)acrylate (hereinbelow, simply referred to as “PMMA”) to be used in the present invention is: homopolymers of methyl acrylate or methyl methacrylate; copolymers of methyl acrylate and methyl methacrylate; or copolymers of at least one member selected from methyl acrylate and methyl methacrylate and other monomer. Examples of other monomer include, but are not restricted to: alkyl(meth)acrylate, such as ethyl methacrylate, n-propyl methacrylate, isopropyl methacrylate, n-butyl methacrylate, isobutyl methacrylate, pentyl methacrylate, hexyl methacrylate, octyl methacrylate, 2-ethylhexyl methacrylate, cyclohexyl methacrylate, dodecyl methacrylate, myristyl methacrylate, palmityl methacrylate, stearyl methacrylate, behenyl methacrylate, methyl acrylate, ethyl acrylate, n-propyl acrylate, isopropyl acrylate, n-butylacrylate, isobutyl acrylate, pentyl acrylate, hexyl acrylate, octyl acrylate, 2-ethylhexyl acrylate, cyclohexyl acrylate, dodecyl acrylate, myristyl acrylate, palmityl acrylate, stearyl acrylate and behenyl acrylate; aromatic vinyl monomers, such as styrene, α-methylstyrene, 1-vinylnaphthalene, 4-methylstyrene, 4-propylstyrene, 4-cyclohexylstyrene, 4-dodecylstyrene, 2-ethyl-4-benzylstyrene, 4-(phenylbutyl)styrene and halogenated styrene; vinyl cyanide monomers, such as acrylonitrile and methacrylonitrile; conjugated diene monomers, such as butadiene and isoprene; esters of methacrylic acid and phenols, such as phenylmethacrylate; methacrylic acid esters, such as esters of methacrylic acid and aromatic alcohol, e.g. benzyl methacrylate.

PMMA which may be used in the present invention is one of the above-mentioned homopolymers or copolymers, used alone or a mixture of two or more thereof.

The flame retardant, which is an essential component of the transparent member for electronic device of the present invention, is a chemical substance which renders flame retardant effect to a resin, such as lowering of a burning velocity and suppression of combustion, when added to the resin. There is no limitation with respect to the flame retardant, and those used in common can be used. Examples of the flame retardant include, but are not restricted to, a bromine flame retardant, a chlorine flame retardant, a phosphorus-containing flame retardant, a silicon-containing flame retardant, a nitrogen compound flame retardant and an inorganic flame retardant. Amongst them, the phosphorus-containing flame retardant and the silicon-containing flame retardant are preferred, since there are less possibilities of hydrogen halide generation due to thermal decomposition during complexing with resin or during molding, which may otherwise corrode a processing machine or molding dies or deteriorate working environment; or generation of halogens which dissipate during waste incineration, or decomposition of the flame retardant which generates noxious substances, such as dioxin, leading to harmful effect on environment.

The phosphorus-containing flame retardant which may be used in the present invention is not specifically limited, and those used in common can be used. Examples include, but are not restricted to, organic phosphorous compounds, such as phosphoric acid esters, condensed phosphoric acid esters and polyphosphate salts.

Examples of the phosphoric acid esters include, but are not restricted to, trimethyl phosphate, triethyl phosphate, tributyl phosphate, tri(2-ethylhexyl) phosphate, tributoxyethyl phosphate, triphenyl phosphate, tricresyl phosphate, trixylenyl phosphate, tris(isopropylphenyl) phosphate, tris(phenylphenyl) phosphate, trinaphthyl phosphate, cresyldiphenyl phosphate, xylenyldiphenyl phosphate, diphenyl(2-ethylhexyl) phosphate, di(isopropylphenyl)phenyl phosphate, monoisodecyl phosphate, 2-acryloyloxyethyl acid phosphate, 2-methacryloyloxyethyl acid phosphate, diphenyl 2-acryloyloxyethyl phosphate, diphenyl 2-methacryloyloxyethyl phosphate, melamine phosphate, dimelamine phosphate, melamine pyrophosphate, triphenylphosphine oxide, tricresylphosphine oxide, diphenyl methanephosphonate and diethyl phenylphosphonate.

Examples of the condensed phosphoric acid esters include, but are not restricted to, aromatic condensed phosphoric acid esters, such as resorcinol polyphenyl phosphate, resorcinol poly(di-2,6-xylyl) phosphate, bisphenol A polycresyl phosphate, hydroquinone poly(2,6-xylyl) phosphate and condensation products thereof.

Examples of phosphate salts include, but are not restricted to, those formed of phosphoric acid or polyphosphoric acid with metals in groups IA-IVB of the periodic table, ammonia, aliphatic amine or aromatic amine. Examples of salts of polyphosphoric acid include, but are not restricted to, metal salts, such as lithium salt, sodium salt, calcium salt, barium salt, iron (II) salt, iron (III) salt, and aluminum salt; aliphatic amine salts, such as methylamine salt, ethylamine salt, diethylamine salt, triethylamine salt, ethylenediamine salt and piperazine salt; and aromatic amine salts, such as pyridine salt and triazine salt.

Still further examples of phosphorous-containing flame retardant include, but are not restricted to: halogen-containing phosphoric acid esters, such as trischloroethyl phosphate, trisdichloropropyl phosphate and tris(β-chloropropyl) phosphate; phosphazene compound in which a phosphorus atom and a nitrogen atom are bonded through double bond; and phosphoric acid ester amide.

These phosphorus-containing flame retardants may be used alone or in combination of two or more thereof. Amongst these phosphorus-containing flame retardants, at least one member selected from triphenyl phosphate, tricresyl phosphate and condensed phosphoric acid esters is preferred.

For the silicon-containing flame retardant to be used in the present invention, there can be mentioned an organosilicon compound having two-dimensional or three-dimensional structure mainly composed of structure unit represented by formula: RₘSi_{(4-m)/2} (where m is an integer of 1 or more, and R is a hydrogen atom, substituted or unsubstituted aliphatic or aromatic hydrocarbon group); and polydimethylsiloxiane in which a side chain or terminal methyl group may or may not be substituted or modified with a hydrogen, a substituted or unsubstituted aliphatic hydrocarbon group or aromatic hydrocarbon group, i.e., sometimes called silicone oil or modified silicone oil. Examples of the substituted or unsubstituted aliphatic or aromatic hydrocarbon groups include, but are not restricted to, alkyl group, cycloalkyl group, phenyl group, benzyl group, amino group, epoxy group, polyether group, carboxyl group, mercapto group, chloroalkyl group, alkyl higher alcohol ester group, alcohol group, aralkyl group, vinyl group and trifluoromethyl group. These silicon-containing flame retardants may be used alone or in combination of two or more thereof. Amongst these silicon-containing flame retardants, silicone oil, modified silicone oil and silicone powder are preferred.

In the present invention, other than the above-mentioned phosphorus-containing flame retardant and silicon-containing flame retardant, different flame retardants can be used as occasion may demand. Examples include, but are not restricted to, inorganic flame retardants, such as magnesium hydroxide, aluminum hydroxide, antimony trioxide, antimony pentoxide, sodium antimonate, zinc hydroxyl stannate, zinc stannate, metastannic acid, tin oxide, tin oxide salt zinc sulfate, zinc oxide, ferrous oxide, ferric oxide, stannous oxide, stannic oxide, zinc borate, ammonium borate, ammonium octamolybdate, metal salts of tungustic acid, complex oxide acid of tungsten and metalloid, ammonium sulfamate, ammonium bromide, zirconium compound, guanidine compound, fluorine compound, graphite and swelling graphite. These flame retardants may be used alone or in combination of two or more thereof.

In the transparent member for electronic device of the present invention, the amounts of the polylactic acid, PMMA and the flame retardant are preferably 25-75 parts by weight, 30-75 parts by weight as polymethyl(meth)acrylate and 0.1-30 parts by weight, respectively.

Further, the transparent member for electronic device of the present invention may include components other than the above-mentioned polylactic acid, PMMA and the flame retardant, for the purpose of improving various properties, such as moldability, heat resistance and flame retardancy, without hindering the purpose of the present invention. For example, there may be added polymers other than the above-mentioned polylactic acid and PMMA; a reinforcing agent, a nucleating agent, a plasticizer, a stabilizer (e.g. antioxidant and UV absorbent), and a mold release agent (a fatty acid, a metal salt of a fatty acid, an oxy fatty acid, a fatty acid ester, a partially saponified aliphatic ester, paraffin, a low-molecular-weight polyolefin, a fatty acid amide, an alkylenebisfatty acid amide, an aliphatic ketone, a fatty acid ester of a lower alcohol, a fatty acid ester of a polyhydric alcohol, a fatty acid ester of polyglycol and modified silicone). Still other examples of the additive include, but are not restricted to, a coloring agent containing dye or pigment.

As for the polymers other than the above-mentioned polylactic acid and PMMA, either thermoplastic polymer or thermosetting polymer can be used. However, the thermoplastic polymer is preferable from the viewpoint of moldability. Examples of the polymers other than polylactic acid include, but are not restricted to: polyolefins, such as low-density polyethylenes, high-density polyethylenes and polypropylenes; polyesters, polyamides, polystyrenes, polyacetals, polyurethanes, aromatic and aliphatic polyketones, polyphenylene sulfides, polyether ether ketones, polyimides, thermoplastic starch resins, acrylic resins, AS resins, ABS resins, AES resins, ACS resins, AAS resins, polyvinyl chloride resins, polyvinylidene chlorides, vinylester resins, MS resins, polycarbonates, polyarylates, polysulfones, polyether sulfones, phenoxy resins, polyphenylene oxides, poly-4-methylpentene-1, polyether imides, cellulose acetates, polyvinyl alcohols, unsaturated polyesters, melamine resins, phenol resins and urea resins. Further examples include, but are not restricted to, ethylene-propylene copolymers, ethylene-propylene-nonconjugated diene copolymers, ethylene-butene-1 copolymers, acrylic rubbers, ethylene-acrylic acid copolymers and alkali metal salts thereof (sometimes called ionomer), ethylene-glycidyl (meth)acrylate copolymers, ethylene-alkyl acrylate ester copolymers (e.g. ethylene-ethyl acrylate copolymers and ethylene-butyl acrylate copolymers), acid-modified ethylene-propylene copolymers, diene rubbers (e.g. polybutadiene, polyisoprene and polychloroprene), copolymers of diene and vinyl monomer (e.g. styrene-butadiene random copolymer, styrene-butadiene block copolymer, styrene-butadiene-styrene block copolymer, styrene-isoprene random copolymer, styrene-isoprene block copolymer, styrene-isoprene-styrene block copolymer, grafting copolymerization product of polybutadiene and styrene, butadiene-acrylonitrile copolymer), polyisobutylenes, copolymers of isobutylene and butadiene or isoprene, natural rubbers, thiol rubbers, polysulfide rubbers, acrylic rubbers, polyurethane rubbers, polyether rubbers and epichlorohydrin rubbers. Still further examples include, but are not restricted to, polymers having various degrees of cross-linking; polymers having various micro structures, such as cis-structure and trans-structure; polymers having vinyl group and the like; polymers having various average particle diameters (in resin composition); polymers having multilayered structure called core-shell rubber composed of a core layer and a plurality of shell layers with adjacent layers being formed of different polymers; and core-shell rubbers containing silicone compound. These polymers may be used alone or in combination of two or more thereof.

For the reinforcing agent, those in a form of fiber, plate, granule or powder for enhancing mechanical properties (impact resistance and anti-deformation of casting at higher temperature) of the thermoplastic resin can be used. Examples include, but are not restricted to, inorganic fiber reinforcing agents, such as glass fiber, asbestos fiber, carbon fiber, graphite fiber, metal fiber, potassium titanate whisker, aluminum borate whisker, magnesium whisker, silicon whisker, wollastenite, sepiolite, asbestos, slag fiber, Zonolite, ellestadite, gypsum fiber, silica fiber, silica-alumina fiber, zirconia fiber, boron nitride fiber, silicon nitride fiber and boron fiber; organic fiber reinforcing agents, such as polyester fiber, nylon fiber, acrylic fiber, regenerated cellulosic fiber, acetate fiber, kenaf, ramie, cotton, jute, hemp, sisal, Manila hemp, flax, linen, silk, sugar cane, wood pulp, waste paper, used paper and wool; and plate-like or granular reinforcing agents, such as glass flake, nonswelling mica, graphite, metal foil, ceramic beads, talc, clay, mica, sericite, zeolite, bentonite, dolomite, kaolin, finely-powdered silicic acid, feldspar powder, potassium titanate, Shirasu-balloons, calcium carbonate, magnesium carbonate, barium sulfate, calcium oxide, aluminum oxide, titanium oxide, aluminum silicate, silicon oxide, gypsum, novaculite, dawsonite and terra alba. These reinforcing agents may be used alone or in combination of two or more thereof. Amongst these reinforcing agents, natural fibers and regenerated fibers are preferred from the viewpoint of making use of carbon-neutral property and biodegradability of the polylactic acid.

In addition, a surface of the reinforcing agent may be covered with thermoplastic resin, thermosetting resin, coupling agent or the like, or the reinforcing agent may be treated with thermoplastic resin, thermosetting resin, coupling agent or the like in order to keep fibrous reinforcing agent bundled.

In the case where the transparent member for electronic device of the present invention includes the reinforcing agent, an amount of the reinforcing agent is preferably approximately 3-50 parts by weight, more preferably approximately 10-30 parts by weight, based on 100 parts by weight of the polylactic acid.

The nucleating agent which may be used in the present invention is not specifically limited, as long as it enhances moldability and heat resistance, and those generally used for polymers can be used. The nucleating agent may be inorganic or organic. Examples of the inorganic nucleating agent include, but are not restricted to, talc, kaolinite, montmorillonite, synthetic mica, clay, zeolite, silica, graphite, carbon black, zinc oxide, magnesium oxide, titanium oxide, calcium sulfate, boron nitride, calcium carbonate, barium sulfate, aluminum oxide, neodymium oxide and metal salts of phenyl phosphonate.

Examples of the organic nucleating agent include, but are not restricted to, metal salts of organic carboxylic acid, such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate and sodium cyclohexanedicarboxylate; salts of organic sulfonic acid, such as sodium p-toluenesulfonate and sodium sulfoisophthalate; carboxylic amides, such as stearic acid amide, ethylenebislauric acid amide, palmitic acid amide, hydroxystearic acid amide, euric acid amide, trimesic acid tris (t-butyl amide); benzylidene sorbitol and the derivatives thereof; metal salts of phosphorous compound, such as sodium-2,2′-methylenebis(4,6-di-t-butylphenyl) phosphate; and 2,2-methylbis(4,6-di-t-butylphenyl) sodium. These inorganic nucleating agents and organic nucleating agents may be used alone or in combination of two or more thereof.

To the transparent member for electronic device of the present invention, plasticizer may be added for the purpose of molding a product into a desired shape with a predetermined moldabililty, while maintaining transparency and flame retardancy. The plasticizer which may be used in the present invention is not specifically limited, and those generally used in production of polymer can be used. For example, a polyester plasticizer, a glycerin plasticizer, a polybasic carboxylic acid ester plasticizer, a polyalkylene glycol plasticizer and an epoxy plasticizer can be mentioned.

Examples of the polyester plasticizers include, but are not restricted to, polyester formed of acid component, such as adipic acid, sebacic acid, terephthalic acid, isophthalic acid, naphthalenedicarboxylic acid, diphenyldicarboxylic acid and rosin, with diol component, such as propylene glycol, 1,3-butanediol, 1,4-butanediol, 1,6-hexanediol, ethylene glycol and diethylene glycol; and polyester formed of hydroxycarboxylic acid, such as polycaprolactone. The end of these polyesters may be terminated with monofunctional carboxylic acid, monofunctional alcohol or epoxy compound.

Examples of the glycerin plasticizers include, but are not restricted to, glycerin monoacetomonolaurate, glycerin diacetomonolaurate, glycerin monoacetomonostearate, glycerin diacetomonooleate and glycerin monoacetomonomontanate.

Examples of the polybasic carboxylic acid ester plasticizers include, but are not restricted to, phthalic acid esters, such as dimethyl phthalate, diethyl phthalate, dibutyl phthalate, dioctyl phthalate, diheptyl phthalate, dibenzyl phthalate and butylbenzyl phthalate; trimellitic acid esters, such as tributyl trimellitate, trioctyl trimellitate and trihexyl trimellitate; adipic acid esters, such as diisodecyl adipate, n-octyl-n-decyl adipate, methyl diglycol butyl diglycol adipate, benzylmethyl diglycol adipate, and benzylbutyl diglycol adipate; citric acid esters, such as acetyl triethyl citrate and acetyl tributyl citrate; azelaic acid esters, such as di-2-ethylhexyl azelate; dibutyl sebacate, and di-2-ethylhexyl sebacate.

Examples of the polyalkylene glycol plasticizers include, but are not restricted to, polyalkylene glycols, such as polyethylene glycol, polypropylene glycol, poly(ethylene oxide-propylene oxide) block and/or random copolymers, polytetramethylene glycol, bisphenols-ethyleneoxide adducts, bisphenols-propylene oxide adducts, and bisphenols-tetrahydrofuran adducts; and terminal epoxidized compounds thereof, terminal esterified compounds thereof, and terminal etherified compounds thereof.

The epoxy plasticizer generally means epoxy triglyceride formed of alkyl epoxide stearate and soybean oil, though epoxy resin which is mainly formed of bisphenol A and epichlorohydrin may also be used.

Examples of other plasticizers include, but are not restricted to, benzoic acid esters of aliphatic polyol, such as neopentyl glycol dibenzoate, diethylene glycol dibenzoate and triethylene glycol di-2-ethylbutyrate; fatty acid amides, such as stearic acid amide; aliphatic carboxylic acid esters, such as butyl oleate; oxyacid esters, such as methyl acetyl ricinoleate and butyl acetyl ricinoleate; pentaerythritol and sorbitols.

In the case where the transparent member for electronic device of the present invention includes the plasticizer, the amount of the plasticizer is preferably 0.01-5 parts by weight, more preferably 0.1-1 part by weight, based on 100 parts by weight of the polylactic acid.

The transparent member for electronic device of the present invention has an impact strength of 2.7-5 kJ/m², preferably 3-5 kJ/m², in terms of Izod impact strength. In the present invention, Izod impact strength was measured in conformity with JIS K7110 (ASTM D-256). Specifically, a test piece (length: 64 mm, width: 12 mm, thickness: 3.2 mm) was produced by injection molding; a notch was formed with an incident angle of 45±0.5° and a point radius R of 0.25±0.05 mm; the test piece was conditioned at 23° C.±2° C. under 50%±5% RH for more than 48 hours; and impact strength was measured with an Izod impact tester. When the Izod impact strength is below 2.7 kJ/m², sufficient impact resistance cannot be obtained, and, in the case where the transparent member for electronic device of the present invention is a tray for copying machine or the like, a problem may arise in that the tray cracks when the tray is pulled out from a mount part.

In the transparent member for electronic device of the present invention, a light transmittance measured at wavelength region of 400 nm -760 nm is 40% or more, preferably 60% or more, for the purpose of simple visual recognition of the presence of next paper supply, for example in the case of members for copy receiving tray or the like.

The transparent member for electronic device of the present invention can be obtained by directly feeding the polylactic acid, PMMA and the flame retardant, as well as other additives arbitrarily added, to the injection molding machine, and molding into a desired shape. As an injection molding machine to be used, there can be mentioned an injection molding machine equipped with a screw having kneading mechanism with which the components of the material to be kneaded in the cylinder are dispersed and mixed with a large shearing force, which promotes homogeneous kneading, and at the same time, a residence time of the molten-kneaded material in the cylinder can be adjusted to obtain sufficient melting and kneading effect. As for the kneading mechanism, there can be mentioned, for example, a part that helps high shearing performance, such as pin (protrusion), rotor and barrier, provided in a middle part of the screw so as to give a large shearing force to a molten-kneaded material passing through the part, to thereby homogeneously melt the material. For example, there can be mentioned a screw having a Dulmage part which helps high dispersion effect (see, for example, Japanese Patent Application Kokai No. H5-237913A, Japanese Patent Application Kokoku Nos. H6-73897 and H6-73898), and those disclosed in Japanese Patent Application Kokai Nos. H6-91726 and 2000-33615. The screw having a Dulmage part is, for example, a full-flighted screw having fins at an end part thereof, the fins having the same length in a screw axis direction, and being arranged in a screw rotation direction (i.e. around the outer circumference of the screw end part).

It is essential that the cylinder temperature during injection molding be not less than a melting point of the polylactic acid or a temperature at which a flow is initiated. When the molding temperature is too low, molding becomes unstable and short or overload occurs in a casting. On the other hand, when the molding temperature is too high, biodegradable polyester resin is degraded, and the casting may have problems, such as poor strength or colored appearance.

### EXAMPLES

The present invention will be explained in further detail below, with reference to Examples and Comparative Examples, though the present invention should not be construed to be limited by the following Examples.

### Example 1-3

In each of Examples 1-3, polylactic acid (PLA: H-100 manufactured by Mitsui Chemicals, Inc.), polymethylmethacrylate (PMMA: VH001 manufactured by Mitsubishi Rayon Co., Ltd.) and triphenyl phosphate (TPP) in respective amounts shown in Table 1 were mixed together, and the resultant mixture was fed to a biaxial kneader-extruder (PCM30-25 manufactured by Ikegai Co., Ltd.) at a cylinder temperature of 220° C., to thereby obtain pellets. The obtained pellets were subjected to an injection molding machine (semiautomatic injection molding machine manufactured by Imoto Corporation) at a cylinder temperature of 220° C. and a mold temperature of 30° C., to thereby obtain a test piece in a form of plate (20×80 mm) having a thickness of 2 mm.

### Example 4

A test piece was prepared in the same manner as in Example 1, except that a silicon-containing flame retardant (Si oil: KF56 manufactured by Shin-Etsu Chemical Co., Ltd.) was used instead of triphenyl phosphate and that a mixture was obtained using the amount shown in Table 1 for each component.

### Example 5

A test piece was prepared in the same manner as in Example 1, except that a mixture was obtained using the amounts shown in Table 1 for polylactic acid, polymethylmethacrylate and triphenyl phosphate.

### Comparative Examples 1-4

In each of Comparative Examples 1-4, a test piece was prepared in the same manner as in Example 1, except that a mixture was obtained using the amounts shown in Table 1 for polylactic acid, polymethylmethacrylate and triphenyl phosphate.

With respect to the test pieces obtained in Examples 1-5 and Comparative Examples 1-4, light transmittance, Izod impact strength and blocking of pellets were measured according to measurement methods which will be described below. The results are shown in Table 1.

Light Transmittance

With respect to a flat plate having a thickness of 2 mm, light transmittance at a wavelength of 400 nm was measured with a spectrophotometer.

Izod Impact Strength

In conformity with JIS K7110 (ASTM D256), in a test piece produced by injection molding, a notch was formed with an incident angle of 45±0.5° and a point radius R of 0.25±0.05 mm. The test piece was conditioned at 23±2° C. under 50±5% RH for more than 48 hours, and impact strength was measured with an Izod impact tester.

Blocking of Pellets

A mixture of polylactic acid, PMMA and flame retardant was subjected to dry at 80° C., and the presence of blocking of the mixture was observed.

TABLE 1

| | PLA | PMMA | TPP | Si oil | | | |
|---|---|---|---|---|---|---|---|
| | (part | (part | (part | (part | Light | Impact | Blocking |
| | by | by | by | by | transmittance | strength | of |
| | weight) | weight) | weight) | weight) | (400 nm) | (kJ/m²) | pellets |
| Example 1 | 30 | 60 | 10 | — | 65% | 3.7 | No |
| Example 2 | 35 | 35 | 30 | — | 61% | 3.4 | No |
| Example 3 | 20 | 75 | 5 | — | 68% | 3.8 | No |
| Example 4 | 49 | 49 | — | 2 | 67% | 4.5 | No |
| Example 5 | 25 | 70 | 5 | — | 66% | 3.8 | No |
| Comparative | 30 | 30 | 40 | — | 69% | 1.1 | Yes |
| Example 1 | | | | | | | |
| Comparative | 80 | 10 | 10 | — | 73% | 2.5 | No |
| Example 2 | | | | | | | |
| Comparative | 100 | — | — | — | 94% | 2.3 | No |
| Example 3 | | | | | | | |
| Comparative | — | 100 | — | — | 93% | 1.7 | No |
| Example 4 | | | | | | | |

The present invention is not limited to the particular embodiments discussed above and may be carried out in various modified forms without departing from the scope of the present invention.

What is claimed is:

1. A transparent member for electronic device comprising:
polylactic acid,
polymethyl(meth)acrylate, and
a flame retardant,
the transparent member having an Izod impact strength of 2.7-5 kJ/m² and a light transmittance at 400 nm-760 nm wavelength region of 40% or more.

2. The transparent member according to claim 1, comprising
25-75 parts by weight of the polylactic acid,
30-75 parts by weight of polymethyl(meth)acrylate, and
0.1-30 parts by weight of the flame retardant.

3. The transparent member according to claim 1, wherein the polylactic acid consists essentially of
polylactic acid or
a blend of polylactic acid with a lactic acid copolymer of lactic acid and a monomer other than lactic acid.

4. The transparent member according to claim 1, wherein the flame retardant is at least one member selected from a phosphorus-containing flame retardant and a silicon-containing flame retardant.

5. The transparent member according to claim 4, wherein the phosphorus-containing flame retardant is at least one member selected from triphenyl phosphate, tricresyl phosphate and condensed phosphoric acid esters.

6. The transparent member according to claim 4, wherein the silicon-containing flame retardant is at least one member selected from silicone oil, modified silicone oil and silicone powder.

7. The transparent member according to claim 1, further comprising at least one member selected from a reinforcing agent, a nucleating agent and a plasticizer.

8. The transparent member according to claim 7, wherein the reinforcing agent is at least one member selected from natural fiber and regenerated fiber.

9. The transparent member according to claim 7, wherein the reinforcing agent is added in an amount of 10-30 parts by weight based on 100 parts by weight of the polylactic acid.

10. The transparent member according to claim 7, wherein the plasticizer is added in an amount of 0.1-1 part by weight based on 100 parts by weight of the polylactic acid.

11. The transparent member according to claim 1, wherein the member is obtained by directly feeding a mixture comprising the polylactic acid, the polymethyl(meth)acrylate and the flame retardant to a cylinder provided in an injection molding machine, melting and kneading the mixture, and conducting injection molding.

12. The transparent member according to claim 11, wherein the cylinder provided in the injection molding machine is equipped with a screw having kneading mechanism, and the member is obtained by mixing and kneading the mixture with the screw, and conducting injection molding.

13. The transparent member according to claim 1, which is used for an electrophotographic copier, a printer or a facsimile machine.

14. The transparent member according to claim 1, which is used as a copy receiving tray, a paper feed tray or a document tray.
